(19) United States
(12) Patent Application Publication
(10) Pub. No.: US 2013/0328884 A1
(43) Pub. Date: Dec. 12, 2013

(54) DIRECT OPENCL GRAPHICS RENDERING

(71) Applicant: Advanced Micro Devices, Inc., Sunnyvale, CA (US)

(72) Inventors: Hong SU, Pudong district (CN); Jian YANG, Shanghai (CN); Yuan XIE, State Collage, PA (US); Jia-Yao CHEN, Shanghai (CN)

(21) Appl. No.: 13/913,071

(22) Filed: Jun. 7, 2013

Related U.S. Application Data
(60) Provisional application No. 61/657,398, filed on Jun. 8, 2012.

(51) Int. Cl. G06T 11/20

(52) U.S. Cl. CPC G06T 11/20
USPC 345/441

(57) ABSTRACT

A method and apparatus for rendering graphics is disclosed. An edge list and polygon list are generated from a polygon based model. Each polygon is handled in parallel. For each polygon, an active edge pair table is generated based on the polygon list and edge list. Active edge pairs are selected from the active edge table based on a minimum position on a predetermined axis. All active edge pairs that intersect a scan line are processed. The processing includes computing a color value for each pixel lying between points where each active edge pair intersects the scan line. The pixel is then rendered and the active edge table is updated.

### CROSS REFERENCE TO RELATED APPLICATIONS

This application claims the benefit of U.S. provisional application No. 61/657,398 filed Jun. 8, 2012, the contents of which is hereby incorporated by reference herein.

### FIELD OF THE INVENTION

The present invention is generally directed to graphics rendering.

### BACKGROUND

Graphics rendering is a processor intensive task. In general, graphics rendering may process each pixel one by one. Even with the increased speed of processors today, the processing of each pixel one by one comes with substantial overhead. In addition, attempts to increase the speed of graphics rendering often tend to be hardware specific.

### SUMMARY

A method and apparatus for rendering graphics is disclosed. An edge list and polygon list are generated from a polygon based model. Each polygon is handled in parallel. For each polygon, an active edge pair table is generated based on the polygon list and edge list. Active edge pairs are selected from the active edge table based on a minimum position on a predetermined axis. All active edge pairs that intersect a scan line are processed. The processing includes computing a color value for each pixel lying between points where each active edge pair intersects the scan line. The pixel is then rendered and the active edge table is updated.

### BRIEF DESCRIPTION OF THE DRAWINGS

A more detailed understanding may be had from the following description, given by way of example in conjunction with the accompanying drawings wherein:

FIG. 1 is an block diagram in which one or more disclosed embodiments may be implemented;

FIG. 2 is a block diagram of an example device in which one or more disclosed embodiments may be implemented;

FIG. 3 is an illustration of a processing unit of the type suitable for heterogeneous computing in which one or more disclosed embodiments may be implemented;

FIG. 4 is an example screen with polygons;

FIG. 5 is an example flowchart for polygon rasterization in accordance with some embodiments;

FIG. 6 shows example data structures and code for a polygon list and an edge list in accordance with some embodiments;

FIG. 7 shows an example data structure and code for an active edge table in accordance with some embodiments;

FIG. 8 shows an example application flow in accordance with some embodiments;

FIG. 9 shows an example OpenCL kernel pipeline in accordance with some embodiments;

FIG. 10 shows an example OpenCL coordinate transform pipeline in accordance with some embodiments;

FIG. 11 shows an example OpenCL prescan pipeline in accordance with some embodiments;

FIG. 12 shows an example OpenCL Z buffer pipeline in accordance with some embodiments;

FIG. 13 shows an example OpenCL rasterizer pipeline in accordance with some embodiments;

FIG. 14 shows an example optimization approach in accordance with some embodiments; and

FIGS. 15A, 15B, 16 and 17 show a comparison between processor rasterization and OpenCL rasterization in accordance with some embodiments.

### DETAILED DESCRIPTION

Described herein is a method and apparatus that improves graphics rendering and processing by making rendering operations faster, while maintaining hardware portability across manufacturers. In particular, a fixed function 3D graphics pipeline is improved or optimized using parallel programming or processing such as, for example, OpenCL.

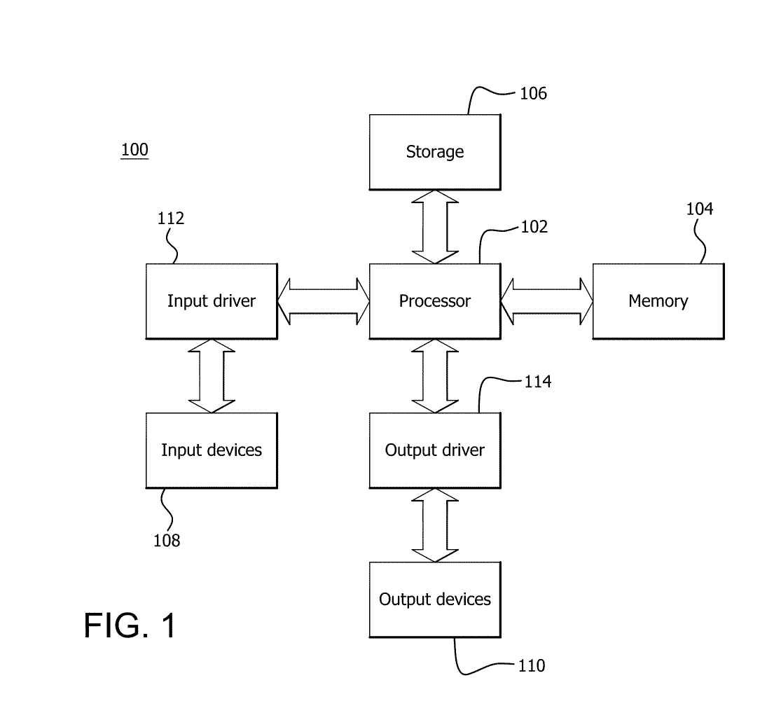

FIG. 1 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

Computers and other such data processing devices have at least one control processor that is a CPU. Such computers and processing devices operate in environments which can typically have memory, storage, input devices and output devices. Such computers and processing devices can also have other processors such as GPUs that are used for specialized processing of various types and may be located with the processing devices or externally, such as, included in the output device. For example, GPUs are designed to be particularly suited for graphics processing operations. GPUs generally comprise multiple processing elements that are ideally suited for executing the same instruction on parallel data streams, such as in data-parallel processing. In general, a CPU functions as the host or controlling processor and hands-off specialized functions such as graphics processing to other processors such as GPUs.

With the availability of multi-core CPUs where each CPU has multiple processing cores, substantial processing capabilities that can also be used for specialized functions are available in CPUs. One or more of the computation cores of multi-core CPUs or GPUs can be part of the same die (e.g., AMD Fusion™) or in different dies (e.g., Intel Xeon™ with NVIDIA GPU). Recently, hybrid cores having characteristics of both CPU and GPU (e.g., CellSPE™, Intel Larrabee™) have been generally proposed for General Purpose GPU (GPGPU) style computing. The GPGPU style of computing advocates using the CPU to primarily execute control code and to offload performance critical data-parallel code to the GPU. The GPU is primarily used as an accelerator. The combination of multi-core CPUs and GPGPU computing model encompasses both CPU cores and GPU cores as accelerator targets. Many of the multi-core CPU cores have performance that is comparable to GPUs in many areas. For example, the floating point operations per second (FLOPS) of many CPU cores are now comparable to that of some GPU cores.

Embodiments described herein may yield substantial advantages by enabling the use of the same or similar code base on CPU and GPU processors and also by facilitating the debugging of such code bases. While described herein with illustrative embodiments for particular applications, it should be understood that the disclosure is not limited thereto. Those skilled in the art with access to the teachings provided herein will recognize additional modifications, applications, and embodiments within the scope thereof and additional fields in which the disclosure would be of significant utility.

Embodiments may be used in any computer system, computing device, entertainment system, media system, game systems, communication device, personal digital assistant, or any system using one or more processors. The embodiments described herein may be particularly useful where the system comprises a heterogeneous computing system. A “heterogeneous computing system,” as the term is used herein, is a computing system in which multiple kinds of processors are available.

Embodiments enable the same code base to be executed on different processors, such as GPUs and CPUs. Embodiments, for example, can be particularly advantageous in processing systems having multi-core CPUs, and/or GPUs, because code developed for one type of processor can be deployed on another type of processor with little or no additional effort. For example, code developed for execution on a GPU, also known as GPU-kernels, can be deployed to be executed on a CPU, using embodiments of the present invention.

An example heterogeneous computing system 100, according to some embodiments, is shown in FIG. 1. Heterogeneous computing system 100 can include one or more processing units, such as processor 102. Heterogeneous computing system 100 can also include at least one system memory 104, at least one persistent storage device 106, at least one input device 108 and output device 110.

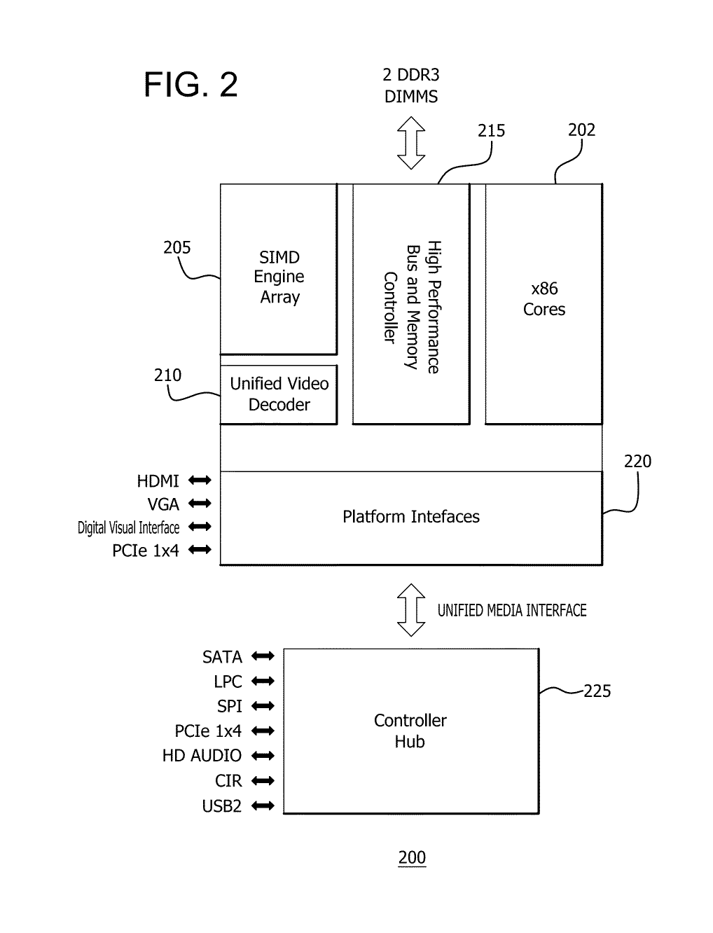

FIG. 2 shows an example heterogeneous processing unit 200 which may include accelerated processing units (APUs). A heterogeneous processing unit 200 includes one or more CPUs and one or more GPUs 202, a wide single instruction, multiple data (SIMD) processor 205 and a unified video decoder 210 that performs functions previously handled by a discrete GPU. Heterogeneous processing units 200 can also include at least one memory controller 215 for accessing system memory and that also provides memory shared between the GPU and CPU and a platform interface 220 for handling communication with input and output devices and interacting with a controller hub.

Rendering is the process of generating an image from a 3D model, (or models in what collectively is called a scene file), by means of a computer program. A scene file contains objects in a strictly defined language or data structure and may contain geometry, viewpoint, texture, lighting, and shading information as a description of the virtual scene. The data contained in the scene file may be passed to a rendering program to be processed and output to a digital image or raster graphics image file. This processing is nominally identified as a graphics rendering pipeline and is executed on a rendering device, such as a GPU.

A rendered image may be understood in terms of a number of visible features. Many rendering algorithms have been researched, and software used for rendering may employ a number of different techniques to obtain a final image. For example, rasterization, including scanline rendering, geometrically projects objects in the scene to an image plane, without advanced optical effects. In another example, ray casting considers the scene as observed from a specific point-of-view, calculating the observed image based only on geometry and very basic optical laws of reflection intensity. In another example, ray tracing is similar to ray casting, but employs more advanced optical simulation, and usually uses Monte Carlo techniques to obtain more realistic results at a speed that is often orders of magnitude slower. Software may combine two or more of these techniques to obtain good-enough results at reasonable cost.

In scanline rendering and rasterization, a high-level representation of an image necessarily contains elements in a different domain from pixels. These elements are referred to as primitives. In rendering of 3D models, triangles and polygons in space might be primitives. If a pixel-by-pixel (image order) approach to rendering is impractical or too slow for some task, then a primitive-by-primitive (object order) approach to rendering may prove useful. Here, loops through each of the primitives may occur to determine which pixels in the image are affected, and the pixels may be modified accordingly. Rasterization is frequently faster than pixel-by-pixel rendering. For example, rasterization ignores large areas of the image that may be empty of primitives. However, the pixel-by-pixel approach can often produce higher-quality images and may be more versatile because it does not depend on as many assumptions about the image as rasterization.

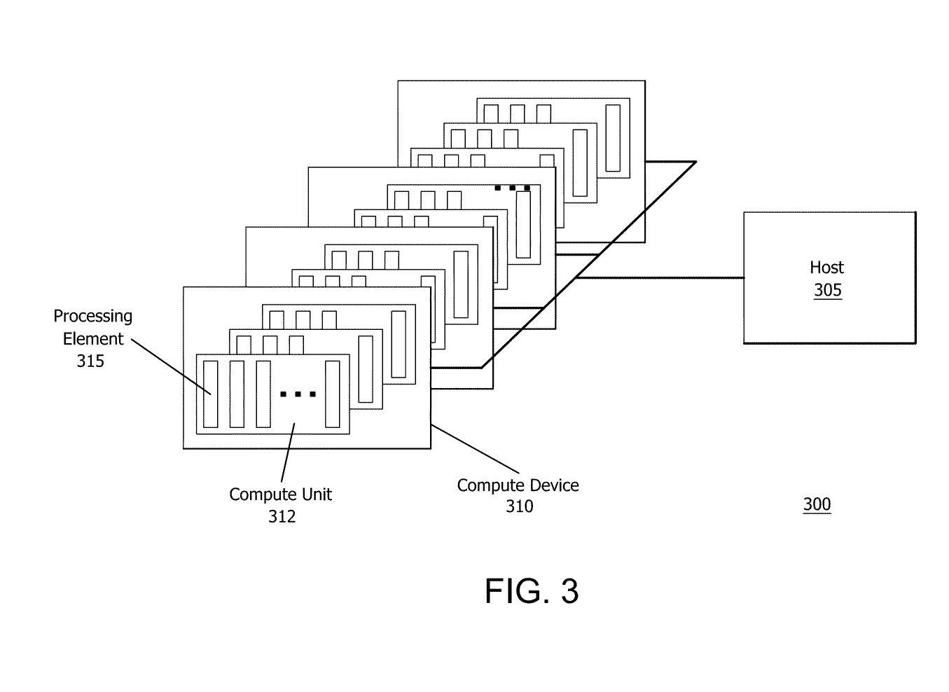

FIG. 3 is an example block diagram of a system 300 in which one or more disclosed embodiments may be implemented using an Open Computing Language (OpenCL) framework for writing programs that execute across a heterogeneous collection of CPUs, GPUs, and other processors. OpenCL systems are designed to support massively parallel processing. OpenCL provides parallel computing using task-based and data-based parallelism and may include an API for coordinating parallel computation across heterogeneous processors and a cross-platform programming language with a well-specified computation environment.

The system 300 includes a host 305 and one or more compute devices 310, (also referred to as OpenCL devices), which may further include one or more computing units 312 that includes processing elements (PEs) 315. An OpenCL application implementation has program code that executes on the host 305 that performs the configuration for a GPU-based application, for example. The host 305 may be a general purpose CPU. The OpenCL implementation also has program code that executes on the computing devices 310, which is denoted as a kernel. Once all of the buffers and kernels are configured, the host program will call an execution function, which will begin execution of the kernel on the GPU. In summary, the host 305 is used to configure kernel execution and the computing devices 310 contain the PEs 315, (i.e., the GPU), that will execute the kernels in parallel. For example, an OpenCL application runs on host 305 and submits commands from the host 305 to execute computations on the PEs 315 within a computing device 310. The PEs 315 execute a single stream of instructions.

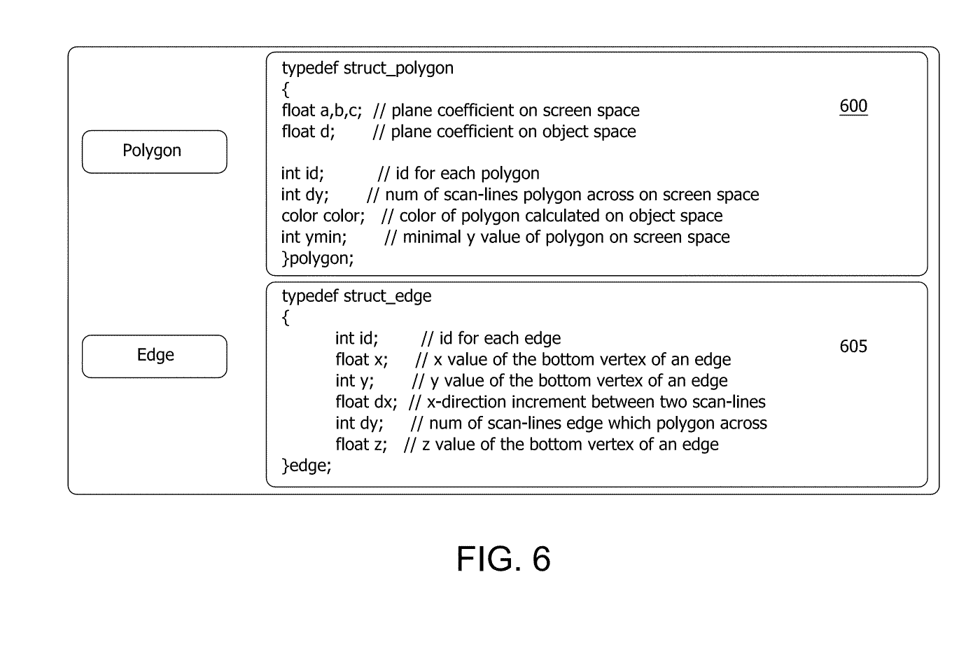

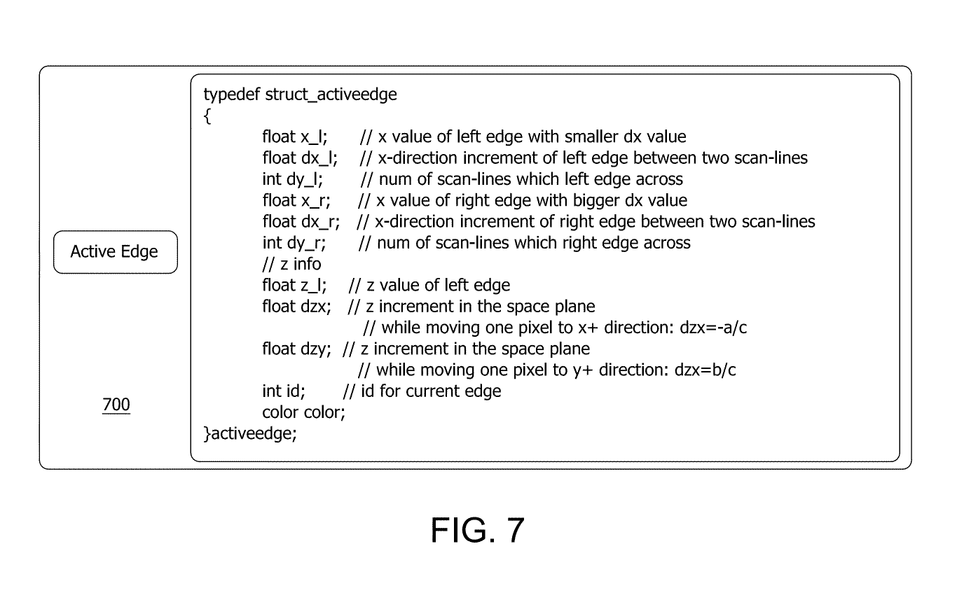

Described herein is polygon rasterization that improves the graphics rendering pipeline by using the parallel processing of OpenCL. The direct OpenCL graphics rendering may improve performance by a factor of 10. For example, in accordance with an embodiment, a module may be created in the OpenCL code module to create a data structure which permits polygons to be processed in parallel to determine, in a serial basis, if particular pixels are in the polygon, as opposed to processing each pixel one by one that is in a screen. For example, in accordance with an embodiment, some specific data structures have been implemented in the programming code to parallel process each polygon. The data structure herein provides a particular way of storing and organizing data for the graphics primitive so that it can then be used more efficiently. For example, FIGS. 6 and 7 show example data structures and code for a polygon list 600, an edge list 605 and an active edge table 700, respectively.

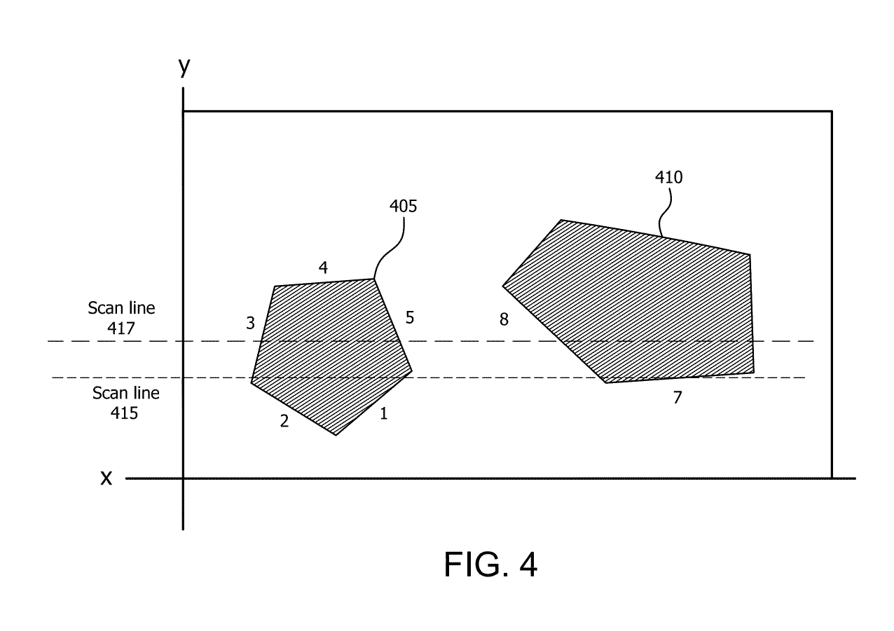

FIG. 4 is an example screen 400 for use with the description below. The screen 400, for purposes of illustration, depicts a number of polygons 405 and 410, and scan lines 415 and 417. Polygon 405 comprises edges 1, 2, 3, 4 and 5.

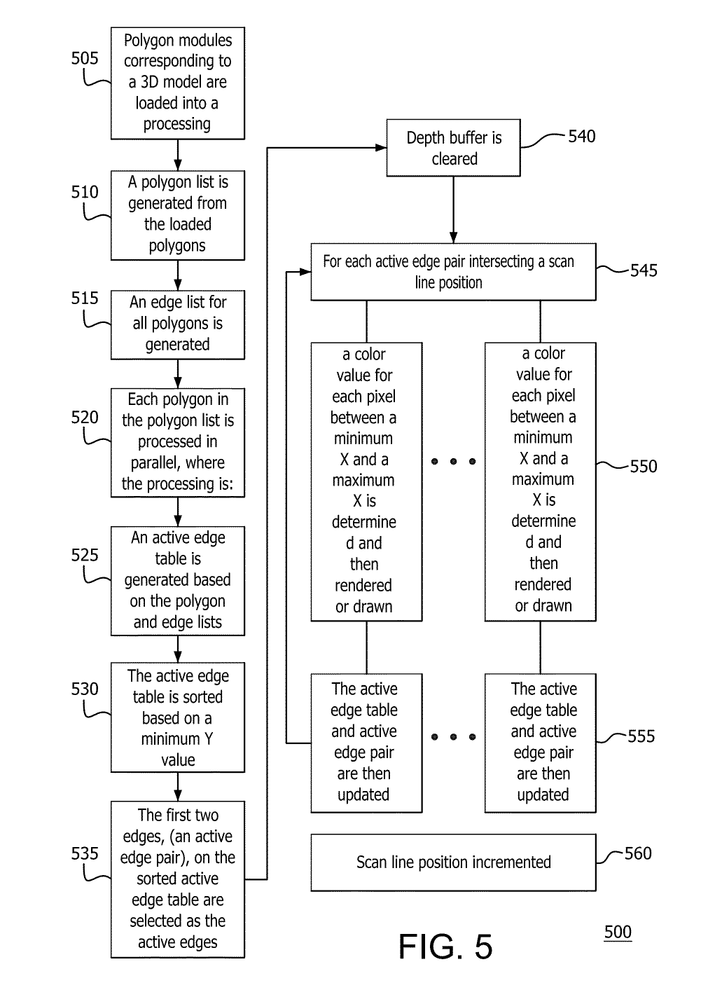

FIG. 5 is a flowchart 500 for polygon rasterization in accordance with some embodiments. The flowchart 500 is illustrative and other flows are implementable based on the description herein. Polygon modules corresponding to a 3D model are loaded into a processing system (505). A polygon list is generated from the loaded polygons (510). An edge list for all of the polygons is generated (515). For each polygon in the polygon list, the following processes are performed (520). An active edge table is generated based on the polygon and edge lists (525). Each element in the active edge table includes a maximum Y, a starting X, and X, Y and Z increments. For example, the intersecting point of edge 2 and edge 3 is a starting X. The active edge table is sorted based on a minimum Y value (530). For example, the top or bottom line of the screen may be chosen as minimum Y and maximum Y would be the opposite end. The first two edges, (an active edge pair), on the sorted active edge table are selected as the active edges (535). There may be more than one active edge pair for a given scan line as shown in FIG. 4. For example, one active edge pair is edge 1 and edge 3 and another active edge pair is edge 7 and 8. In some embodiments, each active edge pair for the given scan line is processed in parallel as described herein below. Other methods may be used to handle each active edge pair that intersects the scan line. As described herein below, the depth or Z buffer(s) is cleared (540).

For each active edge pair intersecting a scan line position, a color value for each pixel between a minimum X and a maximum X is determined and then rendered or drawn (545). The maximum X and minimum X are based on the active edge pair. For example, one minimum X is the intersecting point of scan line 417 and edge 3; while the corresponding maximum X is the intersecting point of Scan line 417 and edge 5. The color value is determined using the depth or Z buffer, which was cleared previously (550). The Z buffer is a 2D array corresponding to the image plane which stores a depth value for each pixel. Whenever a pixel is drawn, it updates the Z buffer with its depth value. Any new pixel must check its depth value against the Z buffer value before it is drawn. Closer pixels are drawn and farther pixels are disregarded.

The active edge table and active edge pair are then updated (555). In particular, the edge whose Y value is equal to the current scan line is removed and the X, Y and Z values for each remaining edge is updated. The scan line is then incremented (560) and a new edge is added to create a new active edge pair based on the incremented scan line. For example with reference to FIG. 4, the active edge pair is originally edges 1 and 3. Edge 1 is then removed because a maximum Y (edge end point) of edge 1 is equal to the scan line 415. The scan line 415 is then moved to scan line 417 and edge 5 is now added to create a new active edge pair.

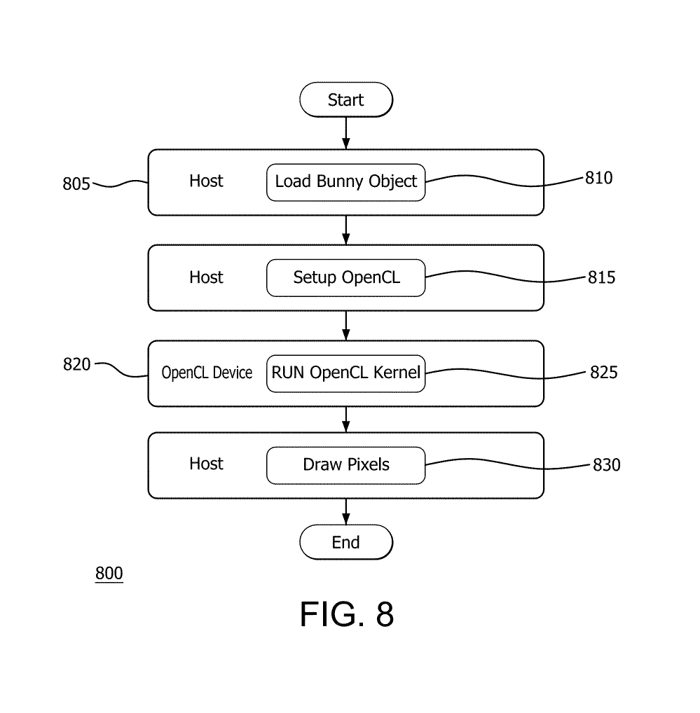

FIG. 8 shows an example application flow 800 using flowchart 500 and data structures 600, 605 and 700. An application runs on a host 805 and submits commands from the host 805 to execute computations on the processing elements within a device as described herein with respect to FIG. 3. A 3D model, for example, Bunny Object, is loaded into memory associated with the host 805 (810). A parallel processing framework, such as OpenCL, is configured and setup (815). The order of OpenCL configuration and model load is not critical but both have to be completed prior to execution of the OpenCL kernels. The OpenCL device(s) 820 then run the kernel(s) as described herein (825). The host 805 then renders the 2D model (830).

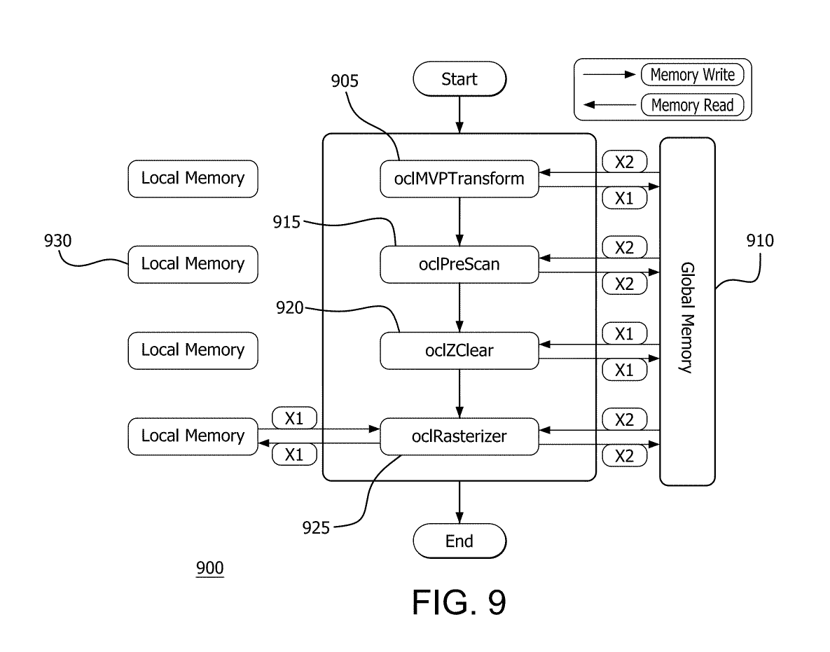

FIG. 9 shows an example OpenCL kernel pipeline 900. The pipeline 900 initially performs a model coordinate to screen coordinate transformation using model view projection matrix and view port information stored in global memory 910 (905). A prescan is performed to generate the polygon and edge lists (915). The Z buffer is cleared (920). During rasterization, the active edge table and active edge pairs are generated and saved in tables (925). In addition, during rasterization, the Z value is checked, the color value for the pixels are computed and the active edge table and active edge pairs are updated as described herein. A local memory 930 is used as a cache to share data between OpenCL work items.

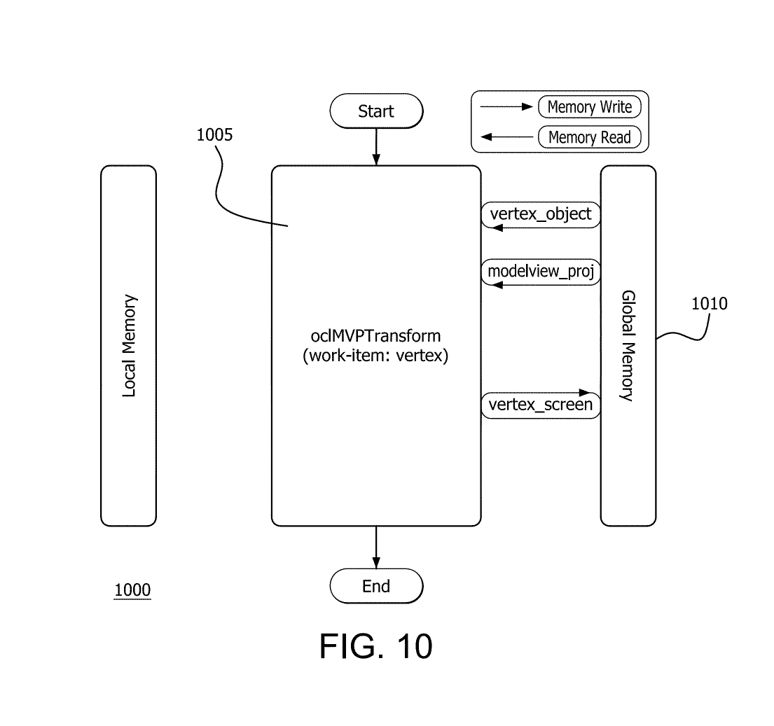

FIG. 10 shows an example OpenCL ModelViewProjection transform pipeline 1000. A ModelViewProjection transform module 1005 reads vertex data in the object space and modelview projection matrix from global memory 1010, transforms the vertex position coordinates into screen view coordinates and writes the screen view coordinates to global memory 1010.

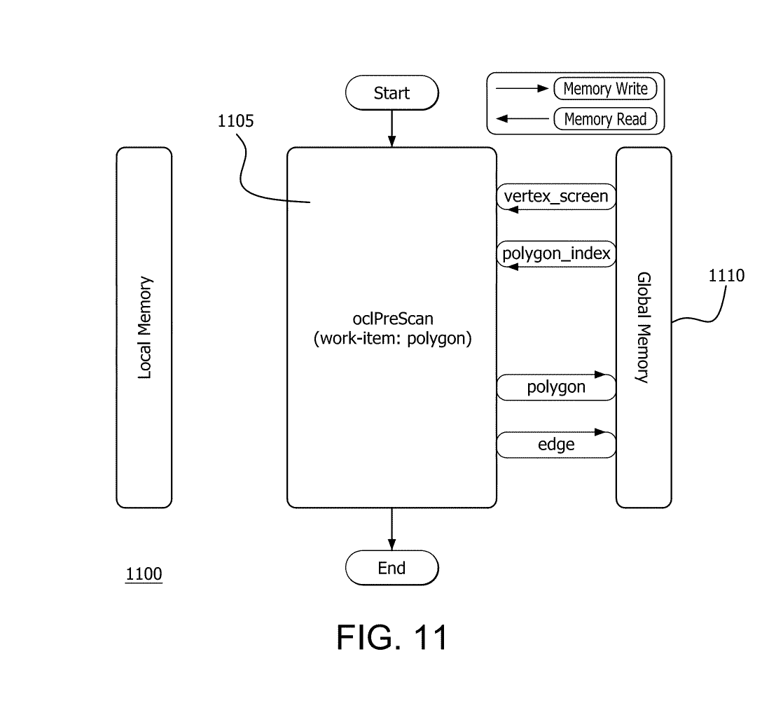

FIG. 11 shows an example OpenCL prescan pipeline 1100. A prescan module 1105 reads the vertex in the screen view space and polygon information from global memory 1110, generates the polygon and edge lists, sorts the edge list according to minimum Y value, and writes the above information to global memory 1110.

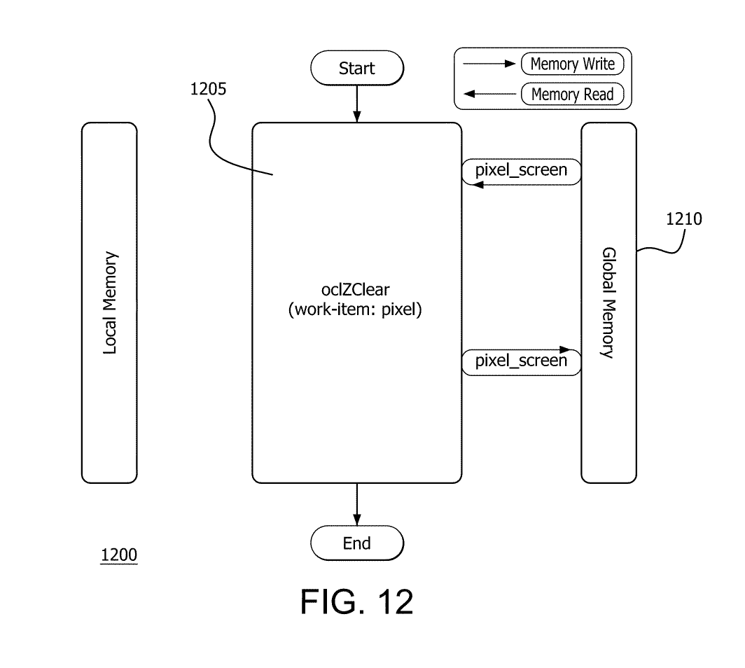

FIG. 12 shows an example OpenCL Z buffer pipeline 1200. A Z buffer clear module 1205 reads the depth value for each pixel in the pixel screen space from global memory 1210, clears the appropriate buffers, and writes the depth value back to global memory 1210.

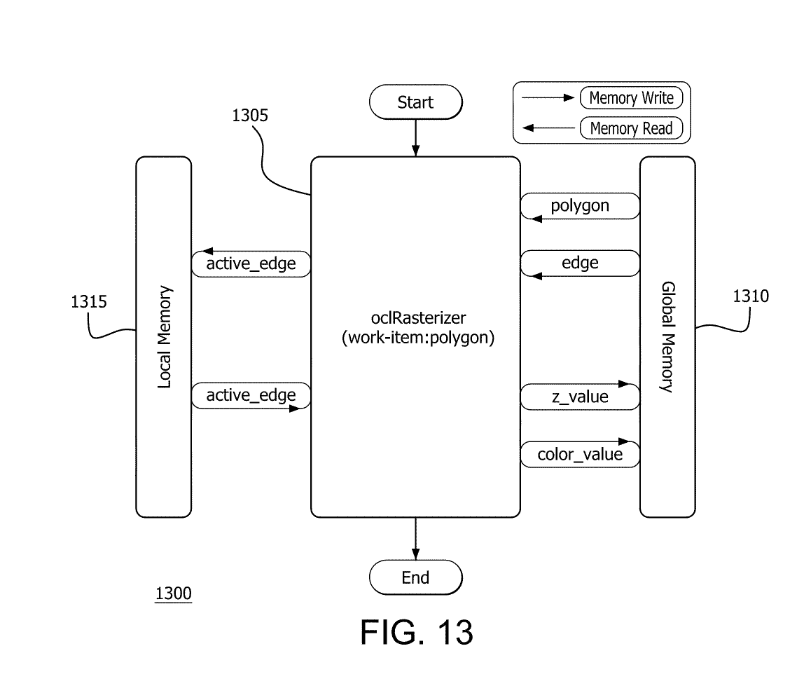

FIG. 13 shows an example OpenCL rasterizer pipeline 1300. A rasterizer module 1305 reads the polygon and edge information from global memory 1310 and active edge pair from local memory 1315, performs a Z value check for each pixel and stores to global memory 1310, generates a color value for the pixel and stores to global memory 1310 as needed, updates active edge pairs and writes the information to local memory 1315.

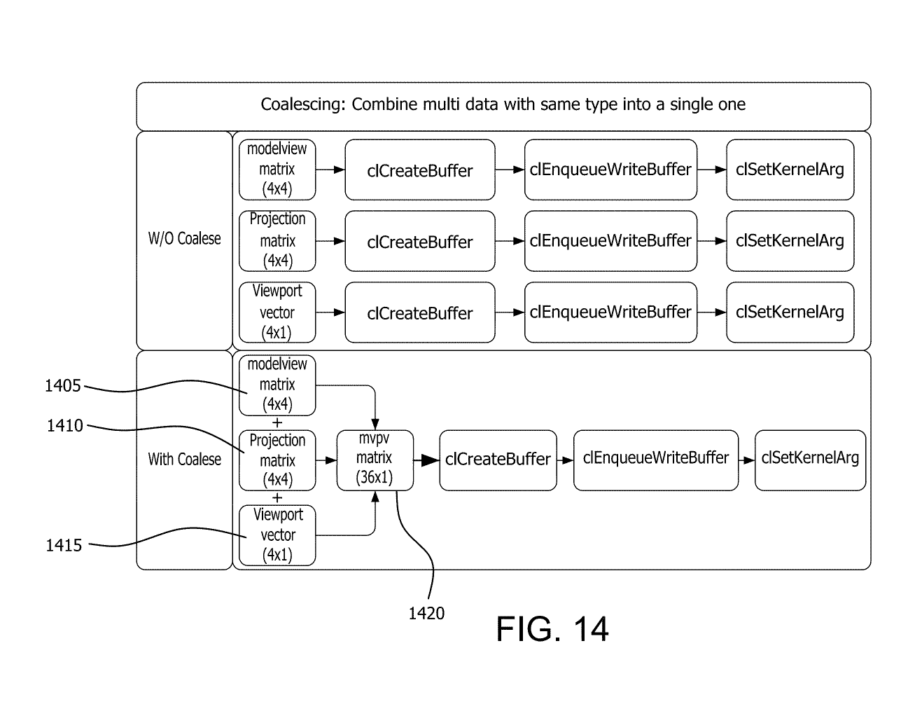

FIG. 14 shows an optimization approach, coalescing, for memory access. Coalescing combines multiple data of the same type, 1405, 1410 and 1415, into a single block 1420. This allow, for example, saving two extra data processing units without any changes on the functional side.

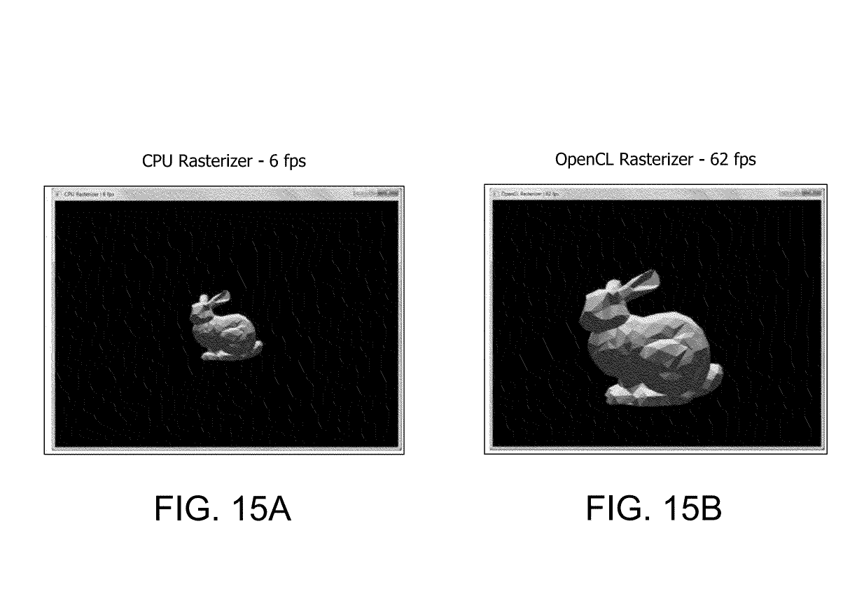

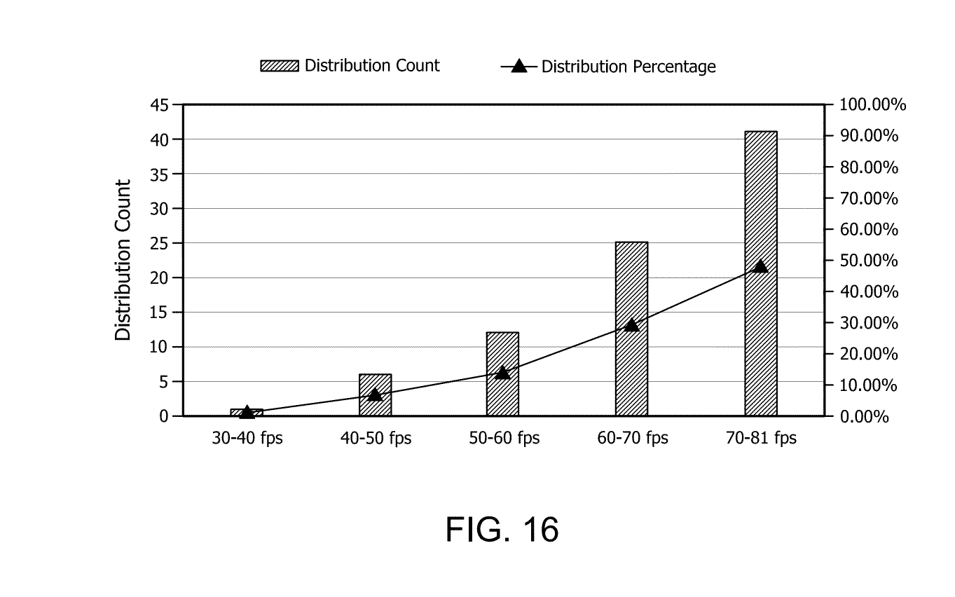

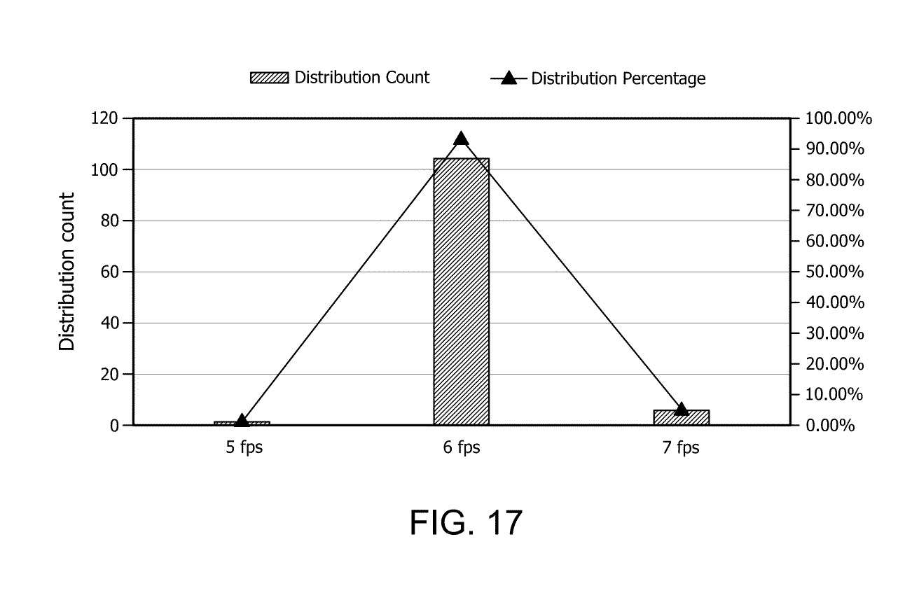

FIGS. 15A, 15B, 16 and 17 and Table 1 show a comparison between processor rasterization and OpenCL rasterization, respectively. As shown in FIGS. 15A and 15B and in Table 1, the processor performs at 6 frames per second (FPS) and the OpenCL version performs at 62 FPS. As shown, OpenCL accelerates polygon rasterization by approximately 10× faster than CPU using the platform identified in Table 1. FIGS. 15A and 15B show two kinds of information: 1) for the functional side, the function is correct for both CPU and OpenCL implementations; and 2), for the performance side (in the way of FPS), the OpenCL approach is 10× faster than the CPU implementation. The recorded FPS count for OpenCL approach is 85 and the average FPS is 67.72 while for CPU approach is 111 and the average FPS is 6.04.

TABLE 1

| Rasterization | OpenCL | CPU |
|---|---|---|
| FPS (average) | 67.72 | 6.04 |
| FPS (min) | 33 | 5 |
| FPS (max) | 81 | 7 |
| FPS recorded count | 85 | 111 |
| FPS faster | 10x | 1x |

OS Platform: Windows 7 32-bit with AMD Turion(tm) II Dual-Core Mobile M500 2.20 GHz, Memory: 4.00 GB, and Dev Platform: Visual Studio 2010

In general, in accordance with some embodiments, a method for rendering graphics in a processor includes generating a polygon list and an edge list from a polygon based model. For each polygon on the list, the following steps are performed in parallel. An active edge pair table is generated based on the polygon list and the edge list. Active edge pairs are then selected from the active edge pair table based on a minimum position on a predetermined axis. In some embodiments, the active edge table is sorted on the predetermined axis. A color value is computed for each pixel lying between points where each active edge pair intersects a scan line. In some embodiments, the color buffer and depth buffer are overwritten if the depth of the pixel is smaller than a depth value stored in the depth buffer. The pixel is rendered and the active edge table is updated. In some embodiments, the edge of the active edge pair is removed on a condition that the scan line and an edge end point are equal and another edge is added to generate another active edge pair.

In some embodiments, a system includes a processor that controls parallel operations of a parallel processing module. The processor generates a polygon list and an edge list from a polygon based model and the parallel processing module processes in parallel for each polygon in the polygon list the methods described herein. In some embodiments, the parallel processing module is an OpenCL (open computing language) device.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the present invention.

The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for rendering graphics in a processor, the method comprising:
generating a polygon list and an edge list from a polygon based model;
processing in parallel for each polygon in the polygon list:
generating an active edge pair table based on the polygon list and the edge list;
selecting active edge pairs from the active edge pair table based on a minimum position on a predetermined axis;
computing a color value for each pixel lying between points where each active edge pair intersects a scan line;
rendering the pixel; and
updating the active edge table.

2. The method of claim 1, further comprising:
overwriting a color buffer and depth buffer on a condition that a depth of the pixel is smaller than a depth value stored in the depth buffer.

3. The method of claim 1, further comprising:
incrementing the scan line.

4. The method of claim 1, wherein each element in the active edge table includes at least a maximum Y, a starting X, and X, Y and Z increments.

5. The method of claim 1, further comprising:
sorting the active edge table on the predetermined axis.

6. The method of claim 1, wherein an edge of the active edge pair is removed on a condition that the scan line and an edge end point are equal.

7. The method of claim 6, wherein another edge is added to generate another active edge pair.

8. A system, comprising:
a processor that controls parallel operations of a parallel processing module;
the processor configured to generate a polygon list and an edge list from a polygon based model;
the parallel processing module configured to process in parallel for each polygon in the polygon list:
generate an active edge pair table based on the polygon list and the edge list;
select active edge pairs from the active edge pair table based on a minimum position on a predetermined axis;
compute a color value for each pixel lying between points where each active edge pair intersects a scan line;
render the pixel; and
update the active edge table.

9. The system of claim 8, further comprising:
the parallel processing module configured to overwrite a color buffer and depth buffer on a condition that a depth of the pixel is smaller than a depth value stored in the depth buffer.

10. The system of claim 8, further comprising:
the parallel processing module configured to increment the scan line.

11. The system of claim 8, wherein each element in the active edge table includes at least a maximum Y, a starting X, and X, Y and Z increments.

12. The system of claim 8, further comprising:
the parallel processing module configured to sort the active edge table on the predetermined axis.

13. The system of claim 8, wherein an edge of the active edge pair is removed on a condition that the scan line and an edge end point are equal.

14. The system of claim 13, wherein another edge is added to generate another active edge pair.

15. The system of claim 1, wherein the parallel processing module is an OpenCL (open computing language) device.

16. A computer readable non-transitory medium including instructions which when executed in a processing system cause the processing system to execute a method for rendering graphics, the method comprising the steps of:
generating a polygon list and an edge list from a polygon based model;
processing in parallel for each polygon in the polygon list:
generating an active edge pair table based on the polygon list and the edge list;
selecting active edge pairs from the active edge pair table based on a minimum position on a predetermined axis;
computing a color value for each pixel lying between points where each active edge pair intersects a scan line;
rendering the pixel; and
updating the active edge table.

17. The computer readable non-transitory medium of claim 16, further comprising:
overwriting a color buffer and depth buffer on a condition that a depth of the pixel is smaller than a depth value stored in the depth buffer.

18. The computer readable non-transitory medium of claim 16, further comprising:
incrementing the scan line.

19. The computer readable non-transitory medium of claim 16, wherein each element in the active edge table includes at least a maximum Y, a starting X, and X, Y and Z increments.

20. The computer readable non-transitory medium of claim 16, further comprising:
sorting the active edge table on the predetermined axis.

21. The computer readable non-transitory medium of claim 16, wherein an edge of the active edge pair is removed on a condition that the scan line and an edge end point are equal.

22. The computer readable non-transitory medium of claim 21, wherein another edge is added to generate another active edge pair.
